(19) United States
(12) Patent Application Publication
(10) Pub. No.: US 2007/0190474 A1
(43) Pub. Date: Aug. 16, 2007

(54) Systems and methods of controlling systems

(76) Inventors: Chao An Su, Jiali Township (TW); Jen-Feng Yao, Yongkang City (TW); Yang Kai Fan, Hsinchu City (TW)

Correspondence Address: DUANE MORRIS LLP;IP DEPARTMENT (TSMC), 30 SOUTH 17TH STREET, PHILADELPHIA, PA, 19103-4196, US

(21) Appl. No.: 11/345,067

(22) Filed: Feb. 1, 2006

(51) Int. Cl. F27D 19/00

(52) U.S. Cl. 432/37

(57) ABSTRACT

A system comprises at least one semiconductor fabrication process apparatus with a fan for providing a downflow. A sensor is disposed on or in a conduit that is fluidly coupled to the semiconductor fabrication process apparatus for releasing an exhaust fluid of a process. The sensor is capable of detecting a characteristic of the exhaust fluid flowing within the conduit and producing a signal indicating the characteristic. A processor is coupled to the sensor. A venting apparatus is coupled to the processor. The processor compares the characteristic of the exhaust fluid with at least one predetermined value to control the venting apparatus.

### BACKGROUND OF THE INVENTION

1. Field of the Invention

The present invention relates to exhaust systems and methods of controlling exhaust systems.

2. Description of the Related Art

With advances of electronic products, semiconductor technology has been widely applied in manufacturing memories, central processing units (CPUs), liquid crystal displays (LCDs), light emission diodes (LEDs), laser diodes and other devices or chip sets. In order to achieve high-integration and high-speed requirements, dimensions of semiconductor integrated circuits have been reduced and various materials and techniques have been proposed to achieve these requirements and overcome obstacles during manufacturing. Controlling the conditions of processing wafers within chambers or tanks thus becomes essential.

One of the important concerns of semiconductor fabrication technology is particles. Particles within process apparatus, such as chambers or wet benches, easily contaminate wafers processed therein. To avoid particle contamination, a downflow is provided within the chamber to force particles flowing downwardly. In addition, an exhauster is also provided to exhaust the gas within the chamber to suppress particle contamination. Under some circumstances when the flow rate or pressure of the gas within the chamber is out of specification, particles within the chamber easily fall on surfaces of wafers and result in contamination of wafers. Operators or engineers then manually adjust the exhauster to exhaust the gas from the chamber, so as to keep the flow rate or pressure of the gas within the desired specifications.

FIG. 1 is a schematic drawing showing a prior art apparatus for conditioning a gas flow to improve a rate of pressure change measurement.

U.S. Patent Publication No. 2004/0182148 provides methods and apparatus for conditioning a gas flow to improve a measurement of a rate of pressure change. An apparatus for conditioning a gas flow to improve the measurement of pressure change rate associated with the gas flow includes a measurement chamber 100 having an interior portion 102 characterized by an internal volume, and an inlet port 110 for receiving the gas flow. The apparatus includes a pressure sensor 104 and a signal processor 106. The signal processor 106 receives and samples the pressure signal from the sensor 104, and calculates a time derivative of the pressure signal. The apparatus also includes an inlet damper 108 disposed at the inlet port 110, so that the gas flow 112 of the reservoir 114 passes through the inlet damper 108 prior to passing into the measurement chamber 100. The inlet damper 108 modifies the gas flow 112 according to a damper transfer function. The chamber volume and the damper transfer function are selected so as to limit the frequencies associated with variations of the pressure in the measurement chamber to a predetermined fraction of the sampling frequency.

U.S. Patent Publication No. 2005/0178433 provides a control system for a bypass duct including a pneumatic damper control assembly, a sensor and a pneumatic switch. The damper control assembly includes a damper vane, mountable in the bypass duct for movement between relative open and closed positions to regulate airflow through the bypass duct. The position of the damper vane is controllable via pressure applied through a damper control line. The sensor is mountable to the supply duct to transmit a pneumatic supply duct signal via a supply line based on at least one of air pressure or air velocity in the supply duct. Finally, the pneumatic switch opens or closes the connection between the damper control line and the supply line based on the difference between the pneumatic supply duct signal and the combination of the pneumatic pressure from the damper assembly and a switch biasing pressure.

Improved exhaust apparatus and methods of controlling exhaust apparatus are desired.

### SUMMARY OF THE INVENTION

In some embodiments, a system comprises at least one semiconductor fabrication process apparatus with a fan for providing a downflow. A sensor is disposed on or in a conduit that is fluidly coupled to the semiconductor fabrication process apparatus for releasing an exhaust fluid of a process. The sensor is capable of detecting a characteristic of the exhaust fluid flowing within the conduit and producing a signal indicating the characteristic. A processor is coupled to the sensor. A venting apparatus is coupled to the processor. The processor compares the characteristic of the exhaust fluid with at least one predetermined value to control the venting apparatus.

In some exemplary embodiments, a system comprises at least one semiconductor fabrication process apparatus, a sensor, a damper, a processor and an exhauster. The semiconductor fabrication process apparatus comprises a filter/fan unit. The sensor is disposed on an exhaust conduit which is fluidly coupled to the semiconductor fabrication process apparatus for releasing an exhaust fluid of a process. The sensor detects a characteristic of the exhaust fluid flowing within the conduit. The damper is disposed on the exhaust conduit. The processor is coupled to the sensor and the damper and compares the characteristic of the exhaust fluid with a predetermined value to control the venting apparatus. The exhauster is attached to the exhaust conduit and adjacent to the damper.

In some exemplary embodiments, a method of controlling a semiconductor process comprises the steps of: (a) providing a downflow in a semiconductor fabrication equipment; (b) sensing at least one characteristic of an exhaust fluid in a conduit, the exhaust fluid including fluid from the downflow; (c) generating a signal when the characteristic of the exhaust fluid falls outside of a predetermined value; and (d) controlling the exhaust fluid based on the signal so that the characteristic of the exhaust fluid substantially falls within the predetermined range.

The above and other features of the present invention will be better understood from the following detailed description of the preferred embodiments of the invention that is provided in connection with the accompanying drawings.

### BRIEF DESCRIPTION OF THE DRAWINGS

Following are brief descriptions of exemplary drawings. They are mere exemplary embodiments and the scope of the present invention should not be limited thereto.

FIG. 1 is a schematic drawing showing a prior art apparatus for conditioning a gas flow to improve a rate of pressure change measurement.

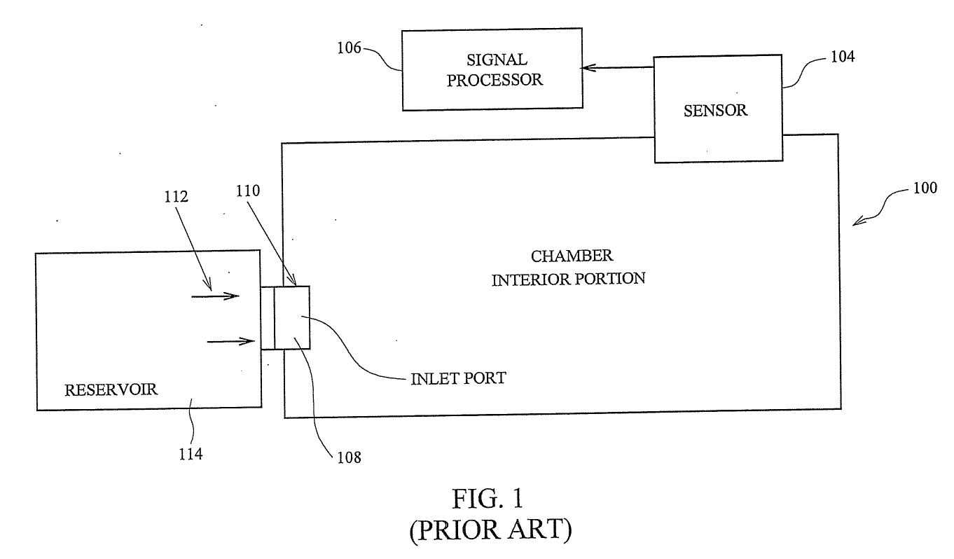

FIG. 2 is a schematic drawing showing an exemplary apparatus.

FIG. 3 is a flowchart of an exemplary method of controlling an exhaust apparatus.

### DESCRIPTION OF THE PREFERRED EMBODIMENT

This description of the exemplary embodiments is intended to be read in connection with the accompanying drawings, which are to be considered part of the entire written description. In the description, relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description and do not require that the system be constructed or operated in a particular orientation.

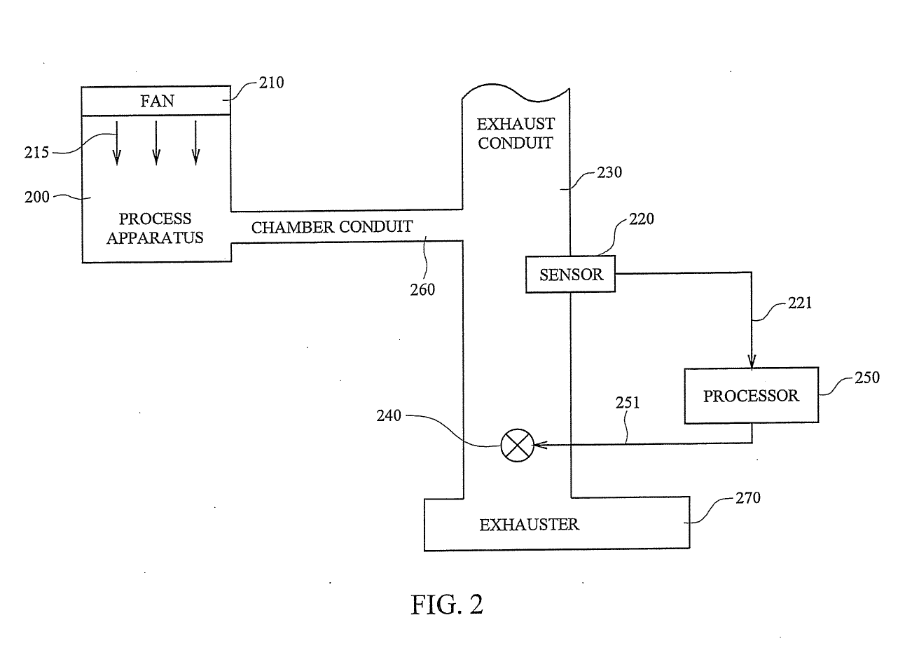

FIG. 2 is a schematic drawing showing an exemplary system. The system comprises at least one semiconductor fabrication process apparatus 200, a sensor 220, a venting apparatus 240, a processor 250 and an exhauster 270. The semiconductor fabrication process apparatus 200 has a fan 210 attached or fluidly coupled thereto. The semiconductor fabrication process apparatus 200 may be connected to the exhaust conduit 230 by way of the process chamber conduit 260. The sensor 220 is disposed on or in the exhaust conduit 230. The venting apparatus 240 is electrically coupled to the sensor 220. The processor 250 is coupled between the sensor 220 and the venting apparatus 240.

The semiconductor fabrication process apparatus 200 can comprise a process chamber, a tank or other semiconductor fabrication process apparatus. For example, in some embodiments, the semiconductor fabrication process apparatus 200 comprises an SEZ-4300 single wafer processing system provided by SEZ Holding Ltd., Zurich, Switzerland or an FC-3000 single bench wet station provided by DNS Electronics LLC, Sunnyvale, Calif. In one embodiment, the semiconductor fabrication process apparatus 200 is attached to the exhaust conduit 230 by way of the process chamber conduit 260. In some embodiments, there are more than one semiconductor fabrication process apparatus 200 attached to the exhaust conduit 230. In some embodiments, the semiconductor fabrication process apparatus 200 can be directly connected to the exhaust conduit 230 without the process chamber conduit 260 therebetween. One skilled in the art can readily obtain a desired system by modifying the design of the semiconductor fabrication process apparatus 200, the exhaust conduit 230 and/or process chamber conduit 260.

Referring to FIG. 2, the semiconductor fabrication process apparatus 200 comprises a fan 210. The fan 210 provides a downflow 215 of gas within the semiconductor fabrication process apparatus 200. The fan 210 can be, for example, a filter/fan unit or other apparatus which is adapted to provide the downflow 215. The flow rate of the downflow 215 is adjustable pursuant to a desired clean level or a desired process condition in the semiconductor fabrication process apparatus 200. In some embodiments, the fan 210 is directly attached to the semiconductor fabrication process apparatus 200. In other embodiments, the fan 210 is attached to the semiconductor fabrication process apparatus 200 by way of a pipe (not shown) or other conduit means, for example, to provide the downflow 215.

Referring again to FIG. 2, the exhaust conduit 230 may be attached to the semiconductor fabrication process apparatus 200 by way of the process chamber conduit 260. The exhaust conduit 230 and the process chamber conduit 260 are adapted to release an exhaust fluid of a process executed within the semiconductor fabrication process apparatus 200. The process chamber conduit 260 may comprise more than one pipe or other fluid transmission medium (e.g., flexible hose or conduit capable of withstanding any expected pressure) to transfer the exhaust fluid from the semiconductor fabrication process apparatus 200 to the exhaust conduit 230. In some embodiments, the process chamber conduit 260 is not required and the exhaust conduit 230 directly contacts the semiconductor fabrication process apparatus 200. One skilled in the art can readily select the number of process chamber conduits 260 and the configuration of the exhaust conduit 230 and the process chamber conduit 260 for a given apparatus.

In some embodiments, the sensor 220 is disposed on the exhaust conduit 230. The sensor 220 comprises a pressure sensor, a flow-rate sensor or other sensors which are adapted to sense changes of pressures or flow rates of the exhaust fluid from the semiconductor fabrication process apparatus 200. After sensing the characteristics, such as pressures or flow rates, of the exhaust fluid flowing in the exhaust conduit 230, the sensor outputs a signal 221 to the processor 250. In some embodiments, the sensor 220 is disposed on the process chamber conduit 260 to detect the flow rate or pressure within the semiconductor fabrication process apparatus 200.

Referring to FIG. 2, the processor 250 is coupled to the sensor 220 and the venting apparatus. The processor 250 receives the signal 221 from the sensor 220 to control the venting apparatus 240. The processor 250 can be, for example, a process automation controller, a programmable logic controller, a microcontroller, a central processing unit (CPU), a computer or other devices that are adapted to process signals 221 sent from the sensor 220.

The venting apparatus 240 is electrically coupled to the sensor 220 through the processor 250. The venting apparatus 240 can be, for example, a damper, a valve, a switch, an exhauster or other device that is adapted to control the flow rates or pressures of exhaust fluids flowing within the exhaust conduit 230. The disposition of the venting apparatus 240 is not limited to that shown in the exemplary drawing of FIG. 2. The venting apparatus 240 can be disposed, for example, on the process chamber conduit 260, on the connection between the semiconductor fabrication process apparatus 200 and the process chamber conduit 260, on the connection between the process chamber conduit 260 and the exhaust conduit, or at other locations where the venting apparatus 240 can be disposed to control the flow rates or pressures of exhaust fluids. In some embodiments, the venting apparatus 240 may comprise a valve of the semiconductor fabrication process apparatus 200, an exhauster of the semiconductor fabrication process apparatus 200, a damper attached to the semiconductor fabrication process apparatus 200 or other apparatus which is disposed in the semiconductor fabrication process apparatus 200 to control the flow rate and pressure of the exhaust fluid therein. One skilled in the art can readily select the disposition of the venting apparatus 240 to obtain a desired exhaust apparatus.

Referring to FIG. 2, the exhauster 270 is attached to the exhaust conduit 230 and adjacent to the venting apparatus 240. In some embodiments, the venting apparatus 240 is not adjacent to the exhauster 270. For example, in another embodiment (not shown) the venting apparatus 240 is disposed on the chamber process conduit 260, and not adjacent to the exhauster 270. In some embodiments, the venting apparatus 240 comprises an exhauster. The processor 250 is able to control the venting apparatus 240, i.e. exhauster, to adjust the pressure or flow rate of the exhaust fluid. Accordingly, if the venting apparatus 240 includes its own exhauster, the exhauster 270 shown in FIG. 2 can be eliminated.

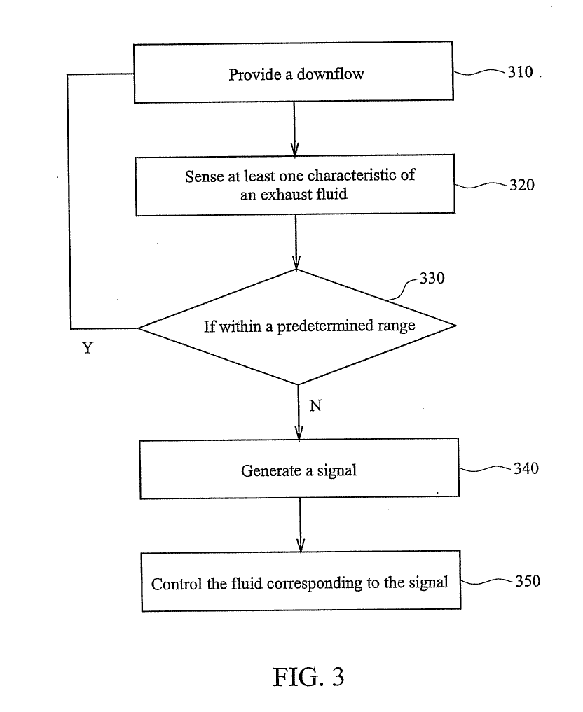

FIG. 3 is a flowchart of an exemplary method of controlling an exhaust apparatus.

At step 310 a downflow is provided. The downflow comprises a gas, such as air or other gas(es) which is adapted to force particles or chemicals within the semiconductor fabrication process apparatus 200 to flow downwardly. In some embodiments, the fan 210 provides the downflow with a flow rate of about 0.2 meter per second (m/s) to about 0.4 m/s. In some embodiments, the semiconductor fabrication process apparatus 200 comprises an SEZ-4300 single wafer processing system for a photoresist strip process. The fan 210 provides the downflow with a flow rate of about 0.32 m/s in the SEZ-4300. In other embodiments, the semiconductor fabrication process apparatus 200 comprises an FC-3000 single bench wet station for a nitride remove process. The fan 210 provides the downflow with a flow rate of about 0.23 m/s in the FC-3000. Because the semiconductor fabrication process apparatus 200 may comprise a variety of wafer processing systems and wet benches, one skilled in the art can readily adjust the flow rate of the downflow to accommodate any given process apparatus 200.

At step 320 at least one characteristic of the exhaust fluid in conduit 230 is sensed by the sensor 220. As set forth above in connection with FIG. 2, the characteristic may be pressure, flow rate and/or other characteristics that are adapted to be sensed to control the clean level or process condition in the semiconductor fabrication process apparatus 200. The exhaust fluid can be, for example, a gas or a liquid. In the exemplary embodiment, the exhaust fluid is a gas comprising a portion of the downflow as well as chemicals exhausted from the semiconductor fabrication process apparatus 200.

At step 330, the processor 250 determines whether the characteristic of the exhaust fluid falls within at least one predetermined value. If the characteristic of the exhaust fluid falls within the predetermined value, the process returns to step 310. If the characteristic of the exhaust fluid does not fall within the predetermined value, the subsequent step 340 is executed.

At step 340, the processor 250 generates a signal 251. The predetermined value with respect to a pressure of the exhaust fluid may be from about 1 hPa to about 4 hPa, for example. The predetermined value with respect to a flow rate of the exhaust fluid may be from about 1.5 m/s to about 6 m/s, for example.

In some embodiments, in which the semiconductor fabrication process apparatus 200 comprises SEZ-4300 single wafer processing system for a photoresist strip process, the processor 250 generates a signal 251 if the sensed pressure falls outside of the range from about 3.0 hectopascal (hPa) to about 3.4 hPa. In other embodiments, in which the semiconductor fabrication process apparatus 200 comprises an FC-3000 single bench wet station for a nitride remove process, the processor 250 generates the signal 251 if the flow rate of the exhaust fluid falls outside of the range from about 4 m/s to about 6 m/s. As described above, a variety of semiconductor fabrication process apparatus 200, downflows 215 and exhaust fluids are used to achieve a desired semiconductor processes. One skilled in the art can readily modify the range of the pressure and flow rate of the exhaust fluid to accommodate any given apparatus.

At step 350 the exhaust fluid is controlled based on the signal generated by the processor 250. For example, if the pressure of the exhaust fluid is higher than about 4 hPa or lower than about 1 hPa, the processor 250 controls the venting apparatus 240 (e.g., a damper), so that the pressure of the exhaust fluid falls within the predetermined value. The processor 250 then controls the damper, valve, switch or exhauster 240, so that a desired pressure or flow rate of the exhaust gas can be obtained.

Although the present invention has been described in terms of exemplary embodiments, it is not limited thereto. Rather, the appended claims should be constructed broadly to include other variants and embodiments of the invention which may be made by those skilled in the field of this art without departing from the scope and range of equivalents of the invention.

What is claimed is:

1. A system, comprising:
at least one semiconductor fabrication process apparatus with a fan for providing a downflow;
a sensor disposed on or in a conduit that is fluidly coupled to the semiconductor fabrication process apparatus for releasing an exhaust fluid of a process, the sensor being capable of detecting a characteristic of the exhaust fluid flowing within the conduit and producing a signal indicating the characteristic;
a processor coupled to the sensor; and
a venting apparatus coupled to the processor, wherein the processor compares the characteristic of the exhaust fluid with at least one predetermined value to control the venting apparatus.

2. The system of claim 1, wherein the fan comprises a filter/fan unit.

3. The system of claim 1, wherein the semiconductor fabrication process apparatus comprises at least one chamber or tank.

4. The system of claim 1, wherein the sensor comprises a pressure sensor or a flow-rate sensor.

5. The system of claim 4, wherein the characteristic comprises a pressure or a flow rate.

6. The system of claim 1, wherein the conduit comprises a process chamber conduit adjacent to the semiconductor fabrication process apparatus.

7. The system of claim 1, wherein the conduit comprises an exhaust conduit.

8. The system of claim 1, wherein the venting apparatus comprises a damper, a valve, a switch or an exhauster.

9. A system, comprising:
at least one semiconductor fabrication process apparatus with a filter/fan unit;
a sensor disposed on an exhaust conduit which is fluidly coupled to the semiconductor fabrication process apparatus for releasing an exhaust fluid of a process, the sensor detecting a characteristic of the exhaust fluid flowing within the conduit;
a damper disposed on the exhaust conduit;
a processor coupled to the sensor and the damper, the processor comparing the characteristic of the exhaust fluid with a predetermined value to control the venting apparatus; and
an exhauster attached to the exhaust conduit adjacent to the damper.

10. The system of claim 9, wherein the semiconductor fabrication process apparatus comprises at least one chamber or tank.

11. The system of claim 9, wherein the sensor comprises a pressure sensor or a flow-rate sensor.

12. The system of claim 11, wherein the characteristic comprises a pressure or a flow rate.

13. A method of controlling a system, comprising the steps of:
(a) providing a downflow in a semiconductor fabrication equipment;
(b) sensing at least one characteristic of an exhaust fluid in a conduit, the exhaust fluid including fluid from the downflow;
(c) generating a signal when the characteristic of the exhaust fluid falls outside a predetermined value; and
(d) controlling the exhaust fluid based on the signal, so that the characteristic of the exhaust fluid substantially falls within the predetermined value.

14. The method of claim 13, wherein a flow rate of the downflow is from about 0.2 m/s to about 0.4 m/s.

15. The method of claim 13, wherein the characteristic comprises a pressure or a flow rate.

16. The method of claim 15, wherein the predetermined range with respect to the pressure is from about 1 hectopascal (hPa) to about 4 hPa.

17. The method of claim 15, wherein the predetermined range with respect to the flow rate is from about 1.5 m/s to 6.0 m/s.

18. The method of claim 15, wherein the downflow is provided by at least one filter/fan unit.

19. The method of claim 15, wherein the conduit comprises an exhaust conduit.

20. The method of claim 19, wherein the step (d) is performed by controlling a damper on the exhaust conduit, which is attached to an exhauster.
